(19) United States
(12) Patent Application Publication
(10) Pub. No.: US 2025/0386282 A1
(43) Pub. Date: Dec. 18, 2025

(54) METHOD AND APPARATUS TO MANAGE NSSAA PROCEDURE IN WIRELESS COMMUNICATION SYSTEM

(71) Applicant: Samsung Electronics Co., Ltd., Gyeonggi-do (KR)

(72) Inventors: Kundan TIWARI, Bangalore (IN); Hoyeon LEE, Gyeonggi-do (KR); Lalith KUMAR, Bangalore (IN); Anikethan Ramakrishna Vijaya KUMAR, Bangalore (IN); Rajavelsamy RAJADURAI, Bangalore (IN); Narendranath Durga TANGUDU, Bangalore (IN); Vanini GUPTA, Bangalore (IN); Nivedya PARAMBATH SASI, Bangalore (IN)

(21) Appl. No.: 19/314,296

(22) Filed: Aug. 29, 2025

Related U.S. Application Data
(63) Continuation of application No. 17/788,561, filed on Jun. 23, 2022.

(30) Foreign Application Priority Data
Dec. 24, 2019 (IN) 201941053778
Dec. 21, 2020 (IN) 201941053778

(51) Int. Cl. H04W 48/12; H04W 12/06; H04W 12/08; H04W 88/18

(52) U.S. Cl. CPC H04W 48/12; H04W 12/06; H04W 12/08; H04W 88/18

(57) ABSTRACT

The present disclosure relates to a pre-5^{th}-Generation (5G) or 5G communication system to be provided for supporting higher data rates Beyond 4^{th}-Generation (4G) communication system such as Long Term Evolution (LTE). According to embodiments of the present disclosure, a method for managing network slice specific authentication and authorization (NSSAA) procedure in wireless communication network is provided.

### CROSS-REFERENCE TO RELATED APPLICATION(S)

This application is a continuation of U.S. application Ser. No. 17/788,561, which was filed in the U.S. Patent and Trademark Office on Jun. 23, 2022, which is a National Phase Entry of PCT International Application No. PCT/KR2020/019074, which was filed on Dec. 24, 2020, and claims priority to Indian Provisional Patent Application No. 201941053778, filed on Dec. 24, 2019, and Indian Complete Patent Application No. 201941053778 filed on Dec. 21, 2020, in the Indian Intellectual Property Office, the entire content of each of which is incorporated herein by reference.

### BACKGROUND

### 1. Field

The present disclosure relates to a method and apparatus to manage a Network Slice-Specific Authentication and Authorization procedure (NSSAA) procedure in a wireless communication network.

### 2. Description of Related Art

To meet the demand for wireless data traffic having increased since deployment of 4G (4^{th}-Generation) communication systems, efforts have been made to develop an improved 5G (5^{th}-Generation) or pre-5G communication system. Therefore, the 5G or pre-5G communication system is also called a ‘beyond 4G network’ or a ‘post LTE system’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancellation and the like.

In the 5G system, hybrid FSK and QAM modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

In general, with advancement in wireless communication technology a user equipment (UE) may subscribe to one or more single-network Slice Selection Assistance Information (S-NSSAI) (s). However, some S-NSSAI(s) is subject to Network Slice-Specific Authentication and Authorization procedure (NSSAA). The NSSAA procedure is triggered for the S-NSSAI requiring the NSSAA procedure with an AAA Server (AAA-S) which may be hosted by a home public land mobile network (H-PLMN) operator or a third party which has a business relationship with the H-PLMN. If the NSSAA procedure is successful for the S-NSSAI then the S-NSSAI is sent to the UE in allowed NSSAI in Registration Accept message. The UE is then allowed to access the service related to the S-NSSAI i.e. the UE may establish a protocol data unit (PDU) session related to the S-NSSAI and access services through the PDU session.

A status of the NSSAA procedure of the S-NSSAI is stored in AMF controller and is transferred to a visiting PLMN (V-PLMN) during mobility or handover to allow a target AMF controller may perform secondary authentication procedures. When the UE moves back to the H-PLMN, the AMF needs to perform the NSSAA procedure again for every S-NSSAI subject to the NSSAA. Also, when the UE is switched OFF, the status of the NSSAA procedure of the S-NSSAI is lost requiring the AMF controller to perform the NSSAA procedure again when the UE is switched ON. The repeated performing of the NSSAA procedure for every S-NSSAI subject to the NSSAA creates unnecessary signaling in the AMF controller leading to loss of large amount of network resources.

Thus, it is desired to address the above mentioned disadvantages or other shortcomings or at least provide a useful alternative.

### SUMMARY

An object of the embodiments herein is to provide a method and AMF controller for managing NSSAA procedure in wireless communication network by storing a status of the NSSAA procedure for a S-NSSAI at a network node and fetching the status of the NSSAA procedure before execution of the NSSAA procedure. The proposed method allows the AMF controller to reduce signaling traffic and also save network resources.

Accordingly the embodiments herein disclose a method for managing NSSAA procedure in wireless communication network. The method includes receiving, by an AMF controller, a first Non-Access Stratum (NAS) message from a user equipment (UE) with a request for at least one network slice selection assistance information (NSSAI) comprising at least one single network slice selection assistance information (S-NSSAI). The at least one S-NSSAI is subject to NSSAA. Further, the method includes performing, by the AMF controller, the NSSAA procedure with authentication authorization and accounting server (AAA-S) in response to the first NAS message and initiating, by the AMF controller, a procedure for storing a status of the NSSAA procedure for the S-NSSAI at one node of a plurality of nodes. The plurality of nodes comprises a unified data management (UDM) controller, authentication server function (AUSF) controller, a authentication authorization and accounting proxy (AAA-P), a policy and charging rules function (PCRF) controller and the AAA-S. The method also includes receiving, by the AMF controller, a second NAS message with a request for the at least one NSSAI comprising the at least one S-NSSAI from the UE and fetching, by the AMF controller, the status of the NSSAA procedure for the at least one S-NSSAI from the at least one node. Further, the method also includes determining, by the AMF controller, whether the status of the NSSAA procedure for the at least one S-NSSAI is successful; and performing, by the AMF controller skip execution of the NSSAA for the at least one S-NSSAI, in response to determining that the status of the NSSAA procedure for the at least one S-NSSAI is successful, and reject the at least one S-NSSAI present in the requested NSSAI, in response to determining that the status of the NSSAA procedure for the at least one S-NSSAI is not successful.

In an embodiment, the method further includes receiving, by the node of the plurality of nodes, a re-authentication and re-authorization request message for the at least one NSSAI comprising the at least one S-NSSAI from the AAA-S for the UE. The UE is identified by a generic public subscription identifier (GPSI) in the re-authentication and re-authorization request message. The method also includes requesting, by the node, an AMF controller identity (ID) to which the UE is registered from the UDM controller and receiving, by the node, a response from the UDM controller indicating that the UE is deregistered. The node requests by sending the GPSI of the UE. Further, the method includes sending, by the node, a message to the UDM controller indicating that one of the re-authentication and re-authorization, and revocation is required for the at least one S-NSSAI and initiating, by the node, the procedure for storing at one of the plurality of nodes the indication that one of the re-authentication and re-authorization, and revocation is required for the at least one S-NSSAI. Then the method includes sending, by the node, a message to the AAA-S indicating that the UE is de-registered.

In an embodiment, the method further includes receiving, by the AMF controller, the indication that one of the re-authentication and re-authorization, and revocation is required for the at least one S-NSSAI from the node of the plurality of nodes when the UE is re-registered; and determining, by the AMF controller, that one of the re-authentication and re-authorization, and revocation is required for the at least one S-NSSAI. Further the method includes performing, by the AMF controller the NSSAA procedure for the at least one S-NSSAI, in response to determining that the re-authentication and the re-authorization is required, and reject the at least one S-NSSAI present in the requested NSSAI, in response to determining that the revocation of the S-NSSAI is required.

In an embodiment, the procedure for storing the status of the NSSAA procedure is initiated by sending a message to the node of the plurality of nodes, wherein the message comprises at least one of a subscription permanent identifier (SUPI) and a GPSI, the at least one S-NSSAI and the status of the NSSAA of the at least one S-NSSAI.

In an embodiment, the method further includes determining, by the AMF controller, that the S-NSSAI of a registered UE is not available in a mapping of allowed NSSAI and eliminating, by the AMF controller, the status of the NSSAA procedure for the at least one S-NSSAI in a UE context.

In an embodiment, the method further includes determining, by the AMF controller, that the S-NSSAI of a registered UE is not available in a mapping of allowed NSSAI and storing, by the AMF controller, an indication in a UE context that the status of the NSSAA procedure for the at least one S-NSSAI in pending. Further, the method includes receiving, by the AMF controller, a third NAS message with a request to register with the at least one S-NSSAI for which the status of the NSSAA procedure is pending; and performing, by the AMF controller, the NSSAA procedure with AAA-Sin response to the third NAS message.

An AMF controller for managing NSSAA procedure in wireless communication network. The AMF controller includes a communicator, a memory, a processor and a NSSAA controller. The NSSAA controller is configured to receive a first NAS message from a UE with a request for at least one NSSAI comprising at least one single network slice selection assistance information (S-NSSAI) and perform the NSSAA procedure with an AAA-S in response to the first NAS message. Further, the NSSAA controller is also configured to initiate a procedure for storing a status of the NSSAA procedure for the S-NSSAI at one node of a plurality of nodes and receive a second NAS message with a request for the at least one NSSAI comprising the at least one S-NSSAI from the UE. Further, the NSSAA controller is also configured to fetch the status of the NSSAA procedure for the at least one S-NSSAI from the at least one node and determine whether the status of the NSSAA procedure for the at least one S-NSSAI is successful. Then the NSSAA controller is also configured to skip execution of the NSSAA for the at least one S-NSSAI, in response to determining that the status of the NSSAA procedure for the at least one S-NSSAI is successful, and reject the at least one S-NSSAI present in the requested NSSAI, in response to determining that the status of the NSSAA procedure for the at least one S-NSSAI is not successful.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF THE DRAWINGS

This disclosure is illustrated in the accompanying drawings, throughout which like reference letters indicate corresponding parts in the various figures. The embodiments herein will be better understood from the following description with reference to the drawings, in which:

FIG. 1 is a block diagram of an AMF controller method for managing an NSSAA procedure in wireless communication network, according to embodiments of the present disclosure;

FIG. 2 is a flow chart illustrating a method for managing the NSSAA procedure in the wireless communication network, according to embodiments of the present disclosure;

FIG. 3 is a signaling diagram illustrating a storage of a NSSAA status of the S-NSSAI subject to the NSSAA in a UDM, according to embodiments of the present disclosure;

FIG. 4 is a signaling diagram illustrating the management of the NSSAA during mobility between 5GS and EPS or N2 handover procedures or handover procedure between the 5GS and the EPS, according to embodiments of the present disclosure;

FIG. 5 is a signaling diagram illustrating the storage of the NSSAA status of the S-NSSAI subject to the NSSAA in a UE, according to embodiments of the present disclosure.

FIG. 6 is a signaling diagram illustrating the method for NSSAA procedure when the UE is de-registered, according to embodiments of the present disclosure;

FIG. 7 is a signaling diagram illustrating the method where a AAA-S requests a re-authentication and re-authorization for a network slice specified by the S-NSSAI in a AAA protocol first message, according to embodiments of the present disclosure;

FIG. 8A is a signaling diagram illustrating the AAA Server triggered network slice-specific re-authentication and re-authorization procedure, according to embodiments of the present disclosure;

FIG. 8B is a signaling diagram illustrating the AAA Server triggered network slice-specific re-authentication and re-authorization procedure, according to embodiments of the present disclosure; and

FIG. 8C is a signaling diagram illustrating the AAA Server triggered network slice-specific revocation procedure, according to embodiments of the present disclosure.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments may be combined with one or more other embodiments to form new embodiments. The term “or” as used herein, refers to a non-exclusive or, unless otherwise indicated. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly the embodiments herein disclose a method for managing NSSAA procedure in wireless communication network. The method includes receiving, by an AMF controller, a first Non-Access Stratum (NAS) message from a user equipment (UE) with a request for at least one network slice selection assistance information (NSSAI) comprising at least one single network slice selection assistance information (S-NSSAI). The at least one S-NSSAI is subject to NSSAA. Further, the method includes performing, by the AMF controller, the NSSAA procedure with authentication authorization and accounting server (AAA-S) in response to the first NAS message and initiating, by the AMF controller, a procedure for storing a status of the NSSAA procedure for the S-NSSAI at one node of a plurality of nodes. The plurality of nodes comprises a unified data management (UDM) controller, authentication server function (AUSF) controller, a authentication authorization and accounting proxy (AAA-P), a policy and charging rules function (PCRF) controller and the AAA-S. The method also includes receiving, by the AMF controller, a second NAS message with a request for the at least one NSSAI comprising the at least one S-NSSAI from the UE and fetching, by the AMF controller, the status of the NSSAA procedure for the at least one S-NSSAI from the at least one node. Further, the method also includes determining, by the AMF controller, whether the status of the NSSAA procedure for the at least one S-NSSAI is successful; and performing, by the AMF controller skip execution of the NSSAA for the at least one S-NSSAI, in response to determining that the status of the NSSAA procedure for the at least one S-NSSAI is successful, and reject the at least one S-NSSAI present in the requested NSSAI, in response to determining that the status of the NSSAA procedure for the at least one S-NSSAI is not successful.

In the conventional methods and systems, the status of the NSSAA procedure of the S-NSSAI is stored in the AMF controller and is transferred to a PLMN during inter-AMF controller mobility scenarios or handover so that a target AMF controller may perform secondary authentication procedures. In scenarios where the inter-AMF controller mobility to the AMF controller does not support the NSSAA procedure or to EPS then the status of the NSSAA procedure is not transferred to the target AMF controller. However, when the UE moves back to other supporting nodes, the AMF needs to perform the NSSAA procedure again for every slice subject to the NSSAA. The repeat performing of the NSSAA procedure again for every slice subject to the NSSAA creates unnecessary signaling in the AMF controller leading to loss of large amount of network resources. Unlike to the conventional methods and systems, in the proposed method the AMF controller stores the status of the NSSAA procedure of the S-NSSAI at the network node and fetches the status of the NSSAA procedure of the S-NSSAI when the AMF controller receives the request from the UE for the S-NSSAI.

In the conventional methods and systems, the status of the NSSAA procedure of the S-NSSAI is lost when the UE is switched off. As result the AMF controller needs to perform the NSSAA procedure again when the UE is switched on. The repeat performing of the NSSAA procedure again for every slice subject to the NSSAA creates unnecessary signaling in the AMF controller leading to loss of large amount of network resources.

Unlike to the conventional methods and systems, in the proposed method the AMF controller receives an indication that re-authentication and re-authorization or revocation is required for the S-NSSAI from the node when the UE is re-registered and the AMF controller fetches the status of the NSSAA procedure of the S-NSSAI when the AMF controller receives the request from the UE for the S-NSSAI. Therefore, the in the proposed method the AMF controller reduces the traffic congestion which may be caused due to large amount of signaling and also saves the network resources.

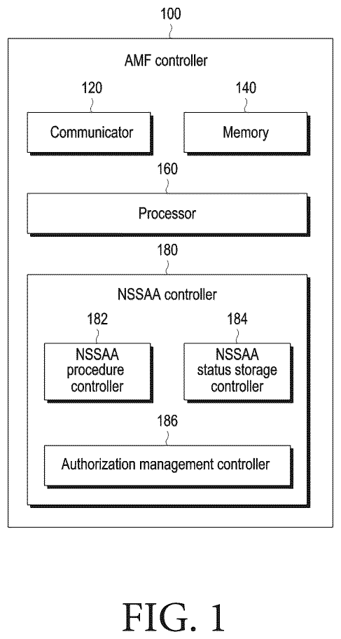

Referring now to the drawings and more particularly to FIGS. 1 through 8C, where similar reference characters denote corresponding features consistently throughout the figure, these are shown preferred embodiments.

FIG. 1 is a block diagram of an AMF controller 100 method for managing NSSAA procedure in wireless communication network, according to the embodiments as disclosed herein.

Referring to the FIG. 1, the AMF controller 100 is a node in the wireless communication network which controls the access and mobility management function (AMF). The AMF controller 100 includes a communicator 120, a memory 140, a processor 160 and a NSSAA controller 180.

In an embodiment, the communicator 120 is configured to receive a first NAS message from a UE 300 with a request for NSSAI including single network slice selection assistance information (S-NSSAI) and a second NAS message with a request for the NSSAI including the same S-NSSAI from the UE 300. The first NAS message is for example but not limited to, a Registration Request message, a service request message. The S-NSSAI is subject to NSSAA. Further, the communicator 120 is also configured to receive an indication that re-authentication and re-authorization or revocation is required for the S-NSSAI from a node when the UE 300 is re-registered. The node is for example but not limited to a unified data management (UDM) controller 500, authentication server function (AUSF) controller 400, a authentication authorization and accounting proxy (AAA-P) 800, a policy and charging rules function (PCRF) controller 900 and the AAA-S 600. Further, the communicator 120 is also configured to receive a third NAS message with a request to register with the S-NSSAI for which a status of a NSSAA procedure is pending.

The memory 140 is configured to store of a status of the NSSAA procedure for the S-NSSAI which is performed by the AAA-S 600. The status of the NSSAA procedure is stored as successful or not successful. The memory 140 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 140 may, in some examples, be considered a non-transitory storage medium. The term “non-transitory” may indicate that the storage medium is not embodied in a carrier wave or a propagated signal. However, the term “non-transitory” should not be interpreted that the memory 140 is non-movable. In certain examples, a non-transitory storage medium may store data that may, over time, change (e.g., in Random Access Memory (RAM) or cache).

The processor 160 is configured to execute various instructions stored in the memory 140 for managing the NSSAA procedure. The processor 160 may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 160 may include multiple cores and is configured to execute the instructions stored in the memory 140.

The NSSAA controller 180 includes a NSSAA procedure controller 182, a NSSAA status storage controller 184 and an authorization management controller 186. The NSSAA controller 180 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the NSSAA determine based on the first NAS message received from the UE 300 that the request for the NSSAI comprising the S-NSSAI is subject to the NSSAA and performs the NSSAA procedure with the AAA-S 600. On performing the NSSAA procedure with the AAA-S 600, the output is the NSSAA procedure is successful or the NSSAA procedure is unsuccessful.

In an embodiment, the NSSAA status storage controller 184 is configured to initiate a procedure for storing the status of the NSSAA procedure for the S-NSSAI at the node of the network by sending a message to the node. The message includes a subscription permanent identifier (SUPI) and a GPSI, the S-NSSAI and the status of the NSSAA of the S-NSSAI. Further, the NSSAA status storage controller 184 is configured to determine that the S-NSSAI of the registered UE 300 is not available in a mapping of allowed NSSAI and eliminate the status of the NSSAA procedure for the S-NSSAI in a UE context. The NSSAA status storage controller 184 is also configured to determine that the S-NSSAI of the registered UE 300 is not available in a mapping of allowed NSSAI and store an indication in the UE context that the status of the NSSAA procedure for the S-NSSAI in pending.

In an embodiment, the authorization management controller 186 is configured to fetch the status of the NSSAA procedure for the S-NSSAI from the node when the second NAS message requesting for the same S-NSSAI is received. Further, the authorization management controller 186 determines whether the status of the NSSAA procedure for the S-NSSAI is successful and skips execution of the NSSAA for the S-NSSAI, on determining that the status of the NSSAA procedure for the S-NSSAI is successful or reject the S-NSSAI present in the requested NSSAI, on determining that the status of the NSSAA procedure for the S-NSSAI is not successful.

Further, the authorization management controller 186 is also configured to determine that the re-authentication and re-authorization, or revocation is required for the S-NSSAI since the UE 300 is de-registered as indicated by the node and perform the NSSAA procedure for the S-NSSAI, on determining that the re-authentication and the re-authorization is required, or reject the at least one S-NSSAI present in the requested NSSAI, on determining that the revocation of the S-NSSAI is required. The node indicates that the UE 300 is de-registered based on a response from the UDM controller 500 when the node requests for an AMF controller identity (ID) to which the UE 300 is registered by sending the GPSI of the UE 300.

The authorization management controller 186 is also configured to perform the NSSAA procedure with the AAA-S 600 on receiving the third NAS message requesting to register with the S-NSSAI for which the status of the NSSAA procedure is pending.

Although the FIG. 1 shows the hardware elements of the AMF controller 100 but it is to be understood that other embodiments are not limited thereon. In other embodiments, the AMF controller 100 may include less or more number of elements. Further, the labels or names of the elements are used only for illustrative purpose and does not limit the scope of the disclosure. One or more components may be combined together to perform same or substantially similar function.

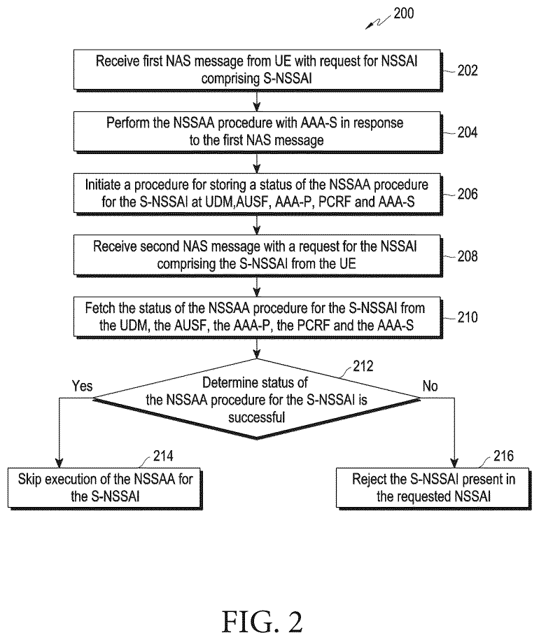

FIG. 2 is a flow chart 200 illustrating a method for managing the NSSAA procedure in the wireless communication network, according to the embodiments as disclosed herein.

Referring to the FIG. 2, at step 202, the AMF controller 100 receives the first NAS message from the UE 300 with the request for the NSSAI comprising the S-NSSAI. For example, in the AMF controller 100 as illustrated in the FIG. 1, the communicator 120 is configured to receive the first NAS message from the UE 300 with the request for the NSSAI comprising the S-NSSAI.

At step 204, the AMF controller 100 performs the NSSAA procedure with the AAA-S 600 in response to the first NAS message. For example, in the AMF controller 100 as illustrated in the FIG. 1, the NSSAA controller 180 may be configured to perform the NSSAA procedure with the AAA-S 600 in response to the first NAS message.

At step 206, the AMF controller 100 initiates the procedure for storing the status of the NSSAA procedure for the S-NSSAI at the node. For example, in the AMF controller 100 as illustrated in the FIG. 1, the NSSAA controller 180 may be configured to initiate the procedure for storing the status of the NSSAA procedure for the S-NSSAI at the node.

At step 208, the AMF controller 100 receives the second NAS message with the request for the NSSAI comprising the S-NSSAI from the UE 300. For example, in the AMF controller 100 as illustrated in the FIG. 1, the communicator 120 is configured to receive the second NAS message with the request for the NSSAI comprising the S-NSSAI from the UE 300.

At step 210, the AMF controller 100 fetches the status of the NSSAA procedure for the S-NSSAI from the node. For example, in the AMF controller 100 as illustrated in the FIG. 1, the NSSAA controller 180 may be configured to fetches the status of the NSSAA procedure for the S-NSSAI from the node.

At step 212, the AMF controller 100 determines whether the status of the NSSAA procedure for the S-NSSAI is successful. For example, in the AMF controller 100 as illustrated in the FIG. 1, the NSSAA controller 180 may be configured to determine whether the status of the NSSAA procedure for the S-NSSAI is successful.

At step 214, the AMF controller 100 skips the execution of the NSSAA for the S-NSSAI, in response to determining that the status of the NSSAA procedure for the S-NSSAI is successful. For example, in the AMF controller 100 as illustrated in the FIG. 1, the NSSAA controller 180 may be configured to skip the execution of the NSSAA for the S-NSSAI, in response to determining that the status of the NSSAA procedure for the S-NSSAI is successful.

At step 214, the AMF controller 100 rejects the S-NSSAI present in the requested NSSAI, in response to determining that the status of the NSSAA procedure for the S-NSSAI is not successful. For example, in the AMF controller 100 as illustrated in the FIG. 1, the NSSAA controller 180 may be configured to reject the S-NSSAI present in the requested NSSAI, in response to determining that the status of the NSSAA procedure for the S-NSSAI is not successful.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

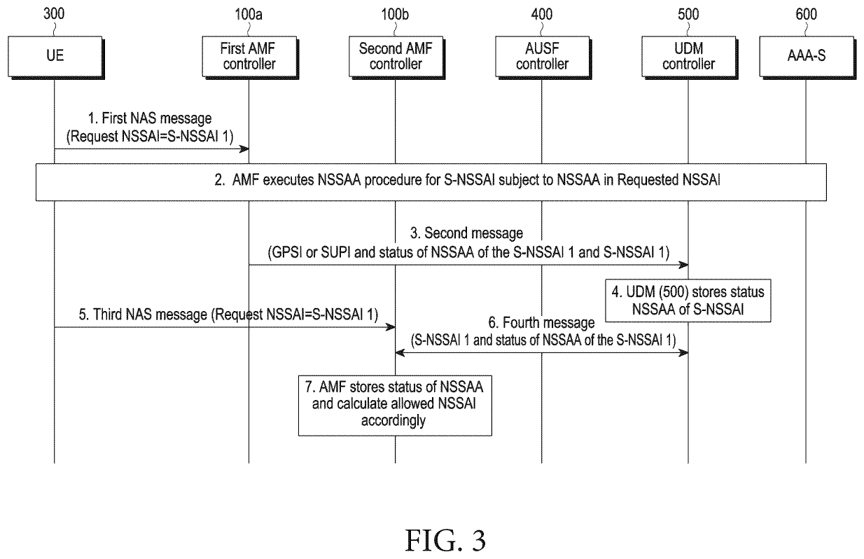

FIG. 3 is a signaling diagram illustrating the storage of the NSSAA status of the S-NSSAI subject to the NSSAA in the UDM 500, according to the embodiments as disclosed herein.

In the conventional methods and systems, NSSAA status of an S-NSSAI subject to NSSAA is stored in the first AMF controller 100a and will be transferred to the second AMF controller 100b during the inter-AMF mobility scenarios or handover so that the second AMF controller 100b needs to perform the secondary authentication procedure. In case inter-AMF mobility to the second AMF controller 100b which does not support the NSSAA or to EPS then the NSSAA status will not be transferred to the second AMF controller 100b. In this case the UE 300 moves back to the supporting nodes and the second AMF controller 100b needs to perform the NSSAA for every slice subject to NSSAA. This will create unnecessary signaling in the second AMF controller 100b. The same problem persists when the UE 300 is switched off, the status of NSSAA is lost and the network needs to perform the NSSAA procedure again when the UE 300 is switched ON.

Referring to the FIG. 3, the step by step sequence of the procedure for storing of the NSSAA status of the S-NSSAI subject to the NSSAA in the UDM 500 is as follows:
1. The UE 300 sends the first NAS message comprising the requested NSSAI consisting of the S-NSSAI subject to the NSSAA to the first AMF controller 100a.
2. The first AMF controller 100a receives the first NAS message and determines that the S-NSSAI in the requested NSSAI is subject to the NSSAA. The first AMF controller 100a initiates the NSSAA procedure as defined in the 3GPP TS 23.502 with the AAA-S 600.
3. After the completion of the NSSAA procedure, the first AMF controller 100a sends the second message (an existing or a new service operation between the first AMF controller 100a and the UDM controller 500) containing (the SUPI or the GPSI or both the SUPI and the GPSI, the S-NSSAI and the status of the NSSAA of the S-NSSAI) to the UDM controller 500 to store the status of the NSSAA procedure for the S-NSSAI. Upon receiving the second message the UDM controller 500 stores the status of the NSSAA procedure. The second message may be sent during any time after the completion of the NSSAA procedure.
4. In one example, the first AMF controller 100a may send a message to store the status of the NSSAA of the S-NSSAI to any node of the wireless communication network. In an example if more than one S-NSSAI(s) are be subjected to the NSSAA, then the network sends the status of NSSAA procedure of more than one S-NSSAI together. In one example it will send status of all S-NSSAA subject to the NSSAA after completion of NSSAA of all S-NSSAI. In one example the status of NSSAA of the S-NSSAI(s) are stored in the AUSF controller 400.
5. When the UE 300 sends the third NAS message containing the requested NSSAI (e.g. Registration Request message during the Registration procedure for initial registration, Registration procedure for mobility and periodic registration update or emergency registration update procedure, the scenario includes mobility between 5GS and EPS or N2 handover procedures or handover procedure between 5GS and EPS) to the second AMF controller 100b.
6. The UDM controller 500, in response to the third NAS message sends the forth message (an existing or a new service operation between the second AMF controller 100b and the UDM controller 500) containing the S-NSSAI and corresponding stored status of the NSSAA of the S-NSSAI(s) to the second AMF controller 100b.
7. When the second AMF controller 100b receives the status of NSSAA of the S-NSSAI(s), the second AMF controller 100b may not execute the NSSAA for the S-NSSAI(s) for which the NSSAA was successful. For the S-NSSAI for which NSSAA was not successful, the second AMF controller 100b rejects the S-NSSAI if present in the Requested NSSAI. The second AMF controller 100b calculates the allowed NSSAI based on the status of the NSSAA of the S-NSSAI.

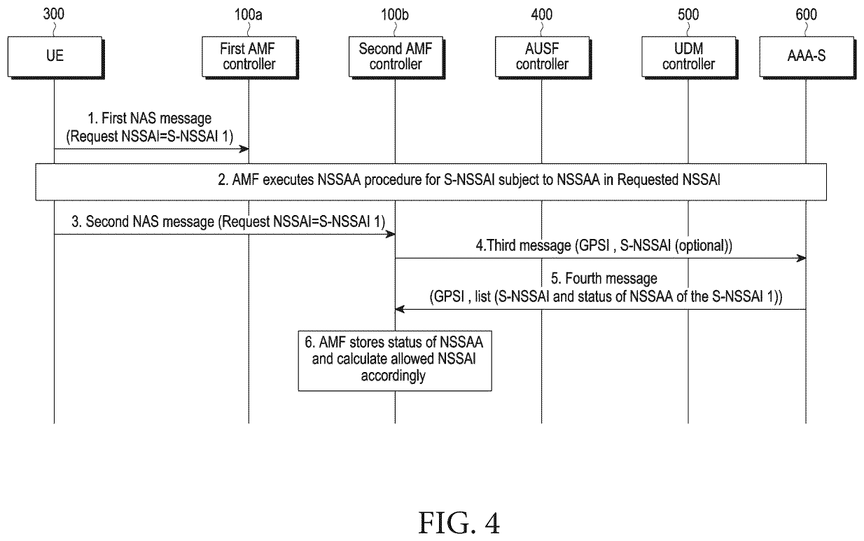

FIG. 4 is a signaling diagram illustrating the management of the NSSAA during mobility between 5GS and EPS or N2 handover procedures or handover procedure between 5GS and EPS, according to the embodiments as disclosed herein.

Referring to the FIG. 4, the step by step sequence of the procedure for the management of the NSSAA during mobility between 5GS and EPS or N2 handover procedures or handover procedure between 5GS and EPS is as follows:
1. The UE 300 sends the first NAS message comprising the Requested NSSAI consisting of the S-NSSAI which is subject to the NSSAA.
2. On receiving the first NAS message, the second AMF controller 100b determines that the UE 300 is the S-NSSAI in the requested NSSAI is subject to the NSSAA. The second AMF controller 100b initiates the NSSAA procedure as defined in TS 23.502 with the AAA-S 600. After the completion of the NSSAA procedure, the AAA-S 600 stores the status of NSSAA of the S-NSSAI.
3. When the UE 300 sends the second NAS message containing the requested NSSAI (e.g. Registration Request message during for the Registration procedure for initial registration, Registration procedure for mobility and periodic registration update or emergency registration update procedure, the scenario includes mobility between 5GS and EPS or N2 handover procedures or handover procedure between 5GS and EPS) to any network node such as the second AMF controller 100b or the UDM controller 500 or the AUSF controller 400.
4. The network node then fetches the status for the NSSAA of the S-NSSAI from the AAA-S 600 by sending the third message (an existing or a new service operation between AMF and AUSF) to the AAA-S 600 containing the UE global identity e.g. GPSI or SUPI, S-NSSAI (optional).
5. The AAA-S 600 provides the status of the NSSAA of the S-NSSAI(s) to the second AMF controller 100b or the UDM controller 500 or the AUSF controller 400 in the fourth message (an existing or a new service operation between the first AMF controller 100a and the AUSF controller 400) containing (UE global identity e.g. GPSI or SUPI and status of the S-NSSAI and corresponding NSSAA status of the S-NSSAI). The UDM controller 500 or the AUSF controller 400 provides the status of the NSSAA of the S-NSSAI to the second AMF controller 100b.
6. When the second AMF controller 100b receives the status of NSSAA of the S-NSSAI(s), the second AMF controller 100b does not execute the NSSAA for the S-NSSAI(s) for which the NSSAA was successful. For the S-NSSAI for which NSSAA was not successful, the second AMF controller 100b rejects the S-NSSAI if present in the Requested NSSAI.

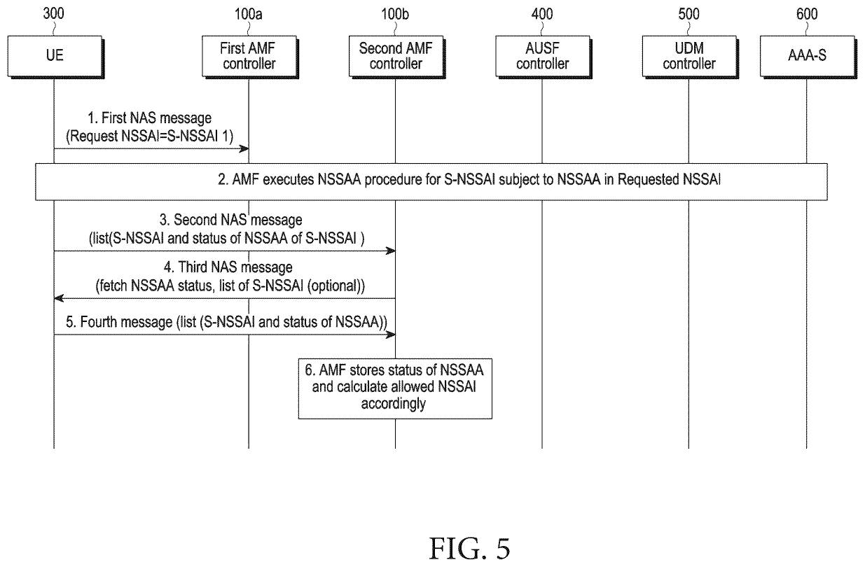

FIG. 5 is a signaling diagram illustrating the storage of the NSSAA status of the S-NSSAI subject to the NSSAA in the UE 300, according to the embodiments as disclosed herein.

In the conventional methods and systems, the UE 300 is registered to the network and the NSSAA is executed for the S-NSSAI which is subject to the NSSAA. The UE 300 is now switched off. The AAA-S 600 initiates the NSSAA procedure for the S-NSSAI as the UE 300 is switched off the NSSAA procedure may not be done. The existing methods and systems do not clearly specify as to how the NSSAA will be performed when the UE 300 is powered ON.

Referring to the FIG. 5, the step by step sequence of the procedure for storing of the NSSAA status of the S-NSSAI subject to the NSSAA in the UE 300 is as follows:
1. The UE 300 sends the first NAS message comprising the Requested NSSAI consisting of the S-NSSAI which is subject to the NSSAA to the first AMF controller 100a.
2. The first AMF controller 100a receives the first NAS message and determines that the S-NSSAI in the requested NSSAI is subject to the NSSAA. The first AMF controller 100a initiates the NSSAA procedure as defined in the 3GPP TS 23.502 with the AAA-S 600. After the completion of the NSSAA procedure, the UE 300 stores the status of NSSAA of the S-NSSAI. In one example the first AMF controller 100a sends the status of the S-NSSAI in a second NAS message (e.g. Configuration updates command).
3. The UE 300 sends status of the NSSAA of the S-NSSAI to the second AMF controller 100b during a NAS procedure (e.g. During a Registration procedure or service request procedure) in a second NAS procedure. The second AMF controller 100b stores the NSSAA of the S-NSSAI. In case the authentication fails or security procedure fails the second AMF controller 100b deletes the NSSAA status received from the UE 300. The NSSAA is sent to the second AMF controller 100b in encrypted NAS message.
4. The second AMF controller 100b may fetch the status of the NSSAA of the S-NSSAI using a NAS procedure e.g. sending a third NAS message requesting the UE 300 to send the status of the NSSAA of the S-NSSAI.
5. The UE 300 sends the status of the NSSAA of the S-NSSAI in the fourth NAS message. The second AMF controller 100b may fetch status of NSSAA of all S-NSSAI or individual S-NSSAI or a group of S-NSSAI upon indicating these options in the third NAS message.
6. When the second AMF controller 100b receives the status of NSSAA of the S-NSSAI(s), the second AMF controller 100b may not execute the NSSAA for the S-NSSAI(s) for which the NSSAA was successful. For the S-NSSAI for which NSSAA was not successful, the second AMF controller 100b rejects the S-NSSAI if present in the Requested NSSAI.

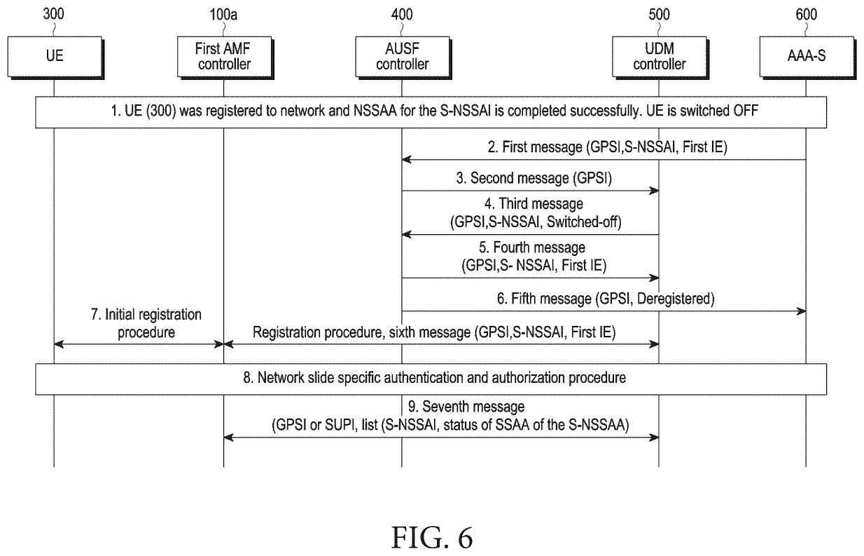

FIG. 6 is a signaling diagram illustrating the method for NSSAA procedure when the UE 300 is de-registered, according to the embodiments as disclosed herein.

In the conventional methods and systems, the UE 300 is registered to the network and the NSSAA has been executed for the S-NSSAI subject to the NSSAA. The UE 300 is then switched off. The AAA-S 600 initiates the NSSAA procedure for the S-NSSAI as the UE 300 is switched off the NSSAA procedure may not be performed. The existing methods and systems do not clearly specify as to how the NSSAA will be performed when the UE 300 is powered ON.

Referring to the FIG. 6, the step by step sequence of the procedure for providing the NSSAA procedure for a switch off to define abort procedure/the UE 300 is deregistered consists of following steps:
1. The UE 300 sends the first NAS message comprising the Requested NSSAI consisting of the S-NSSAI which is subject to the NSSAA to the first AMF controller 100a.
2. The AAA-S 600 requests the re-authentication and re-authorization for the Network Slice specified by the S-NSSAI in the AAA protocol first message (an existing or a new service operation between the AUSF controller 400 and the AAA-S 600) (UE global identity e.g. GPSI, S-NSSAI) (e.g. Re-Auth Request message), for the UE 300 identified by the GPSI in this message. The first message is sent to an AAA-P 800, if the AAA-P 800 is used (e.g. the AAA Server belongs to a third party), otherwise it is sent directly to the AUSF controller 400. The AAA-P 800, if present, relays the first message to the AUSF controller 400.
3. The AUSF controller 400 sends a second message (an existing or a new service operation between AUSF controller 400 and UDM controller 500) containing (UE global identity e.g. GPSI) to the UDM controller 500 to get the AMF ID to which the UE 300 is registered.
4. On receiving the second message, the UDM controller 500 determines that the UE 300 is deregistered from the network. The UDM controller 500 sends the third message (an existing or a new service operation between the AUSF controller 400 and UDM controller 500) containing (UE global identity e.g. GPSI) and a second information element indicating the UE 300 is deregistered to the AUSF 400.
5. The AUSF 400 sends a fourth message (an existing or a new service operation between the first AMF controller 100a and UDM controller 500) to the UDM controller 500 containing (the S-NSSAI and the second information element indicating that re-authentication and re-authorization or revocation is required for the S-NSSAI). On receiving the fourth message the UDM controller 500 stores the S-NSSAI and instruction that re-authentication and re-authorization or revocation is required for the S-NSSAI.
6. The AUSF controller 400 sends fifth message (an existing or a new service operation between the AUSF controller 400 and AAA-S 600) to the AAA-S indicating the UE 300 is de-registered. The AAA-S 600 aborts the NSSAA re-authentication and re-authorization procedure or revocation procedure.
7. When the UDM 500 receives a sixth message indicating that the UE 300 is registered, then the UDM 500 transfer the stored indication and S-NSSAI to the first AMF controller 100a. (Steps 6 and 7 may take place in any order). The first AMF controller 100a determines that re-authentication and re-authorization is pending then the first AMF controller 100a performs the NSSAA procedure. If the revocation of the S-NSSAI is pending then the first AMF controller 100a rejects the S-NSSAI if present in the Requested NSSAI. After successful completion of the NSSAA procedure for the S-NSSAI, the first AMF controller 100a may update the UDM 500 that the re-authentication and re-authorization is successful.
8. If the NSSAA procedure fails or the Slice-Specific Authorization Revocation is triggered for the S-NSSAI and the S-NSSAI is not in the allowed NSSAI list, then the first AMF controller 100a sends a NAS message to the UE 300 containing S-NSSAI as rejected S-NSSAI. In one example the first AMF controller 100a sends the NAS message containing the S-NSSAI and information element indicating the Slice-Specific Authorization is revoked. Upon receiving the NAS message the UE 300 shall not send the S-NSSAI in the Request NSSAI to get the service related to the S-NSSAI until the UE 300 is powered off and powered on again or performs deregistration procedure. When the AAA-S 600 removes Slice-Specific Authorization Revocation i.e. allow the user to use the S-NSSAI, the AAA-S 600 sends the message to the AUSF controller 400 indicating that the UE 300 is allowed to use S-NSSAI or alternatively the AAA-S 600 invokes re-authentication and re-authorization procedure. The AUSF controller 400 sends the message to the first AMF controller 100a indicating the first AMF controller 100a that the UE is allowed to use services of S-NSSAI. The first AMF controller 100a then allows the UE 300 to use S-NSSAI or the first AMF controller 100a forwards the indication that the UE 300 is again allowed to use the S-NSSAI in a NAS message. Upon receiving the indication in the NAS message, the UE 300 may send S-NSSAI in Requested S-NSSAI in the Registration Request message, i.e. the UE 300 may sends S-NSSAI in the NAS message to the network to get the service. In case the AAA-S 600 invokes re-authentication and re-authorization for the S-NSSAI then after successful NSSAA procedure the first AMF controller 100a allows the UE 300 to use S-NSSAI or the UE 300 may send S-NSSAI as Requested NSSAI in the Registration Request message.
9. In one example the first AMF controller 100a stores the indication that S-NSSAI slice specific authorization is revoked. The first AMF controller 100a passes the indicator to the target second AMF controller 100b during the idle mode mobility procedure or N2 handover procedure of the UE 300. The second AMF controller 100b uses the indicator as described.

In one example when the UE 300 registered to the network the network indicates to the AAA-S that the UE is registered to the network. When the UE id deregistered to the network the network indicates to the AAA-S that the UE is deregistered to the network. The AAA-S 600 server initiates network slice specific re-authorization and re-authentication or revocation when the AAA-S 600 determines that the UE 300 is registered to the network.

In one example when the NSSAA or network slice re-authentication and re-authorization is taking place is initiated and the AMF is performing de-registration procedure or while performing when the NSSAA or network slice re-authentication and re-authorization procedure, de-registration procedure is triggered at the AMF (e.g. UE 300 initiated de-registration procedure or AMF or UDM controller 500 initiated de-registration procedure then the AMF stores the status of NSSAA or network slice re-authentication and re-authorization procedure (e.g. status of NSSAA of S-NSSAI is the NSSAA has been completed or NSSAA is pending for the S-NSSAI if the NSSAA has not been completed, similar for the network slice specific re-authentication and re-authorization procedure) at the UDM controller 500. The UE 300 and the network follow the procedure defined in this embodiment.

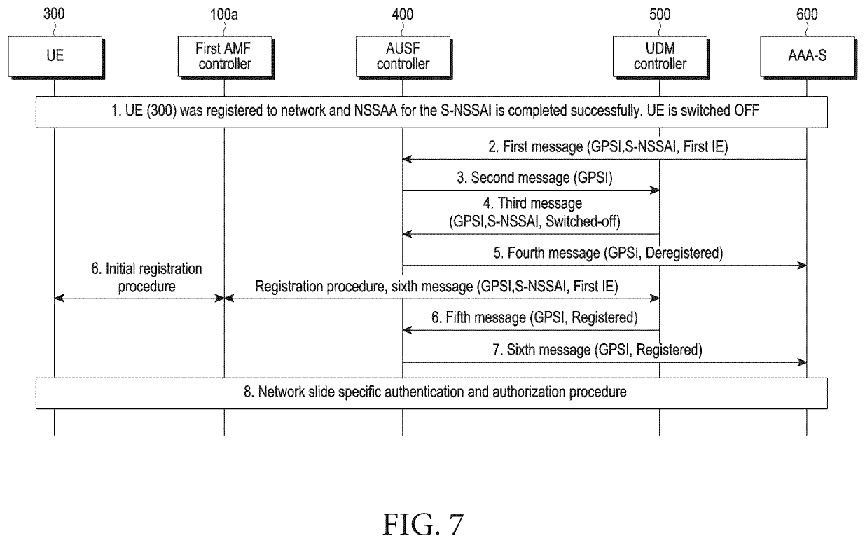

FIG. 7 is a signaling diagram illustrating the method where the AAA-S 600 requests the re-authentication and re-authorization for the Network Slice specified by the S-NSSAI in the AAA protocol first message, according to the embodiments as disclosed herein.

In the conventional methods and systems, when the UE 300 is registered to the network for the S-NSSAI and the NSSAA has been performed for the S-NSSAI and the UE 300 performs initial registration procedure or mobility registration procedure, the S-NSSAI is not included in the allowed list. This may be because the S-NSSAI was rejected or not sent by in the requested S-NSSAI and the AAA-S 600 initiate's network slice specific re-authentication and re-authorization procedure then it is not clear how the first AMF controller 100a will perform network the slice specific re-authentication and re-authorization procedure.

Referring to the FIG. 7, the step by step sequence of the procedure where the AAA-S 600 requests the re-authentication and re-authorization for the Network Slice specified by the S-NSSAI in the AAA protocol first message consists of following steps:
1. A UE 300 is registered to the network and the allowed NSSAI consists of the S-NSSAI subject to the NSSAA and the NSSAA has been performed successfully.
2. The AAA-S 600 requests the re-authentication and re-authorization for the Network Slice specified by the S-NSSAI in the AAA protocol first message (an existing or a new service operation between the AUSF controller 400 and AAA-S 600) (GPSI) (e.g. Re-Auth Request message), for the UE 300 identified by the GPSI in this message. The first message is sent to the AAA-P 800, if the AAA-P 800 is used (e.g. the AAA Server belongs to a third party), otherwise it is sent directly to the AUSF controller 400. The AAA-P 800, if present, relays the first message to the AUSF controller 400.
3. The AUSF controller 400 sends a second message (an existing or a new service operation between the AUSF controller 400 and UDM controller 500) to the UDM controller 500 to get the AMF ID to which the UE 300 is registered.
4. On receiving the second message, the UDM controller 500 determines that the UE 300 is deregistered from the network. The UDM controller 500 sends a third message (an existing or a new service operation between the first AMF controller 100a and UDM controller 500) to the AUSF controller 400 that the UE 300 is deregistered.
5. The AUSF controller 400 sends forth message (an existing or a new service operation between the first AMF controller 100a and UDM controller 500) to the AAA-S 600 indicating the UE 300 is de-registered. The AAA-S 600 stores the information that the UE 300 switched off and re-authentication and re-authorization for the Network Slice specified or the revocation by the S-NSSAI is pending.
6. When the UDM controller 500 determines that the UE 300 is registered successfully to the network then the UDM controller 500 sends the fifth message (an existing or a new service operation between the first AMF controller 100a and UDM controller 500) to the AUSF controller 400 indicating the UE 300 is registered to the network.
7. The AUSF controller 400 sends a sixth message (an existing or a new service operation between the AUSF controller 400 and AAA-S 600) to the AAA-S 600 that the UE 300 is registered to the network.
8. On receiving the sixth message the AAA-S 600 determines that UE 300 was de-registered and re-authentication and re-authorization or revocation for the Network Slice specified by the S-NSSAI is pending then the AAA-S 600 initiates re-authentication and re-authorization for the Network Slice specified by the S-NSSAI or revocation procedure.

In another embodiment, the proposed method provides following steps:
1. The UE 300 is registered to a network and NSSAA has been performed successfully for the S-NSSAI.
2. The UE 300 changes a registration area and does not send the S-NSSAI in the Registration Request message for the mobility or the S-NSSAI is in the rejected S-NSSAI list (The S-NSSAI is not in the allowed NSSAI list).
3. The AAA-S 600 initiates Network Slice-Specific Re-authentication and Re-authorization procedure for the S-NSSAI by sending a first message to the AUSF which forwards the message to the AMF serving the UE 300.
4. The first AMF controller 100a determines that the S-NSSAI is not allowed NSSAI list. The AMF executes one for the following steps.
i. The first AMF controller 100a executes the NSSAA procedure for the S-NSSAI and stores the outcome in the first AMF controller 100a. When the first AMF controller 100a receives the S-NSSAI in the requested NSSAI, the first AMF controller 100a calculates whether S-NSSAI is allowed or not depending on the status of NSSAA of the S-NSSAI. E.g. the NSSAA of the S-NSSAI was performed successfully then the first AMF controller 100a consider the S-NSSAI as allowed and if the NSSAA of the S-NSSAI was not successful, then the first AMF controller 100a shall reject the S-NSSAI.
ii. The first AMF controller 100a stores in the UE context that the NSSAA is pending. The AMF sends a message to the AAA-S 600 that the network slice specific re-authentication and re-authorization is pending. When the UE 300 receives the S-NSSAI in the requested NSSAI contained in a NAS message the first AMF controller 100a initiates the NSSAA procedure for the S-NSSAI. In case of mobility or handover to the different first AMF controller 100a then the first AMF controller 100a sends the indication that network slice specific re-authentication and re-authorization is pending for the S-NSSAI to the second AMF controller 100b. When the second AMF controller 100b receives the S-NSSAI in the Requested NSSAI then the second AMF controller 100b initiates the NSSAA procedure for the S-NSSAI and stores the result of the NSSAA procedure. In case the UE 300 is de-registered before the first AMF controller 100a receives the S-NSSAI in the requested NSSAI, the first AMF controller 100a sends a message to the UDM controller 500 to store the indication that Slice specific re-authentication and re-authorization needs to be done for the S-NSSAI. When the UDM controller 500 receives a message from the first AMF controller 100a that the UE 300 is registered/registering to the network, the UDM controller 500 passes this info to the first AMF controller 100a. The first AMF controller 100a performs NSSAA as per the procedure described in the step 4.
iii. The first AMF controller 100a sends a message to the AAA-S 600 via the AUSF controller 400 or any network node or AF, that the network slice specific re-authentication and re-authentication procedure is not possible. It also indicates the S-NSSAI is not present to the Requested NSSAI i.e. the UE 300 is not requesting a service for the S-NSSAI. When the AMF receives the S-NSSAI in the requested NSSAI in the NAS message it indicates to the first AMF controller 100a that the UE 300 has requested the service for the S-NSSAI. The AAA-S 600 server sends a message to initiates the network slice specific re-authentication and re-authorization procedure. The first AMF controller 100a executes the NSSAA for the S-NSSAI.

In the conventional methods and systems, the UE 300 has been registered to a PLMN and the NSSAA procedure for the S-NSSAI has been performed successfully and the S-NSSAI is in the allowed NSSAI list. The UE 300 changes the registration area, initiates mobility registration procedure, requested NSSAI contains the S-NSSAI and the network slice specific re authentication and re-authorization is also pending for the S-NSSAI. Now, it is not clear how the first AMF controller 100a will calculate handle the service related to the S-NSSAI. In yet another embodiment, the proposed method provides following steps:
1. The UE 300 has been registered to a PLMN and the NSSAA procedure for the S-NSSAI has been performed successfully and the S-NSSAI is in the allowed NSSAI list. The network slice re-authentication and re-authorization procedure is pending or is ongoing.
2. The UE 300 changes the registration area and initiates mobility registration update procedure and transmits registration request message containing requested NSSAI which contains the S-NSSAI. The second AMF controller 100b fetches the UE context from the first AMF controller 100a. The UE context indicates that the network slice re-authentication and re-authorization procedure is pending for the S-NSSAI. In one example, the second AMF controller 100b receives the network slice re-authentication and re-authorization request from the AAA-S 600 during the mobility registration procedure.

The second AMF controller 100b performs one of the following procedure:
1. If the PDU session related to the S-NSSAI has been established in the first AMF controller 100a and transferred to the second AMF controller 100b, the second AMF controller 100b sends S-NSSAI as Allowed NSSAI during the registration procedure. The UE 300 and the network maintains the PDU session related to the S-NSSAI. The first AMF controller 100a continues with the network slice re-authentication and re-authorization procedure for the S-NSSAI.
2. If the PDU session related to the S-NSSAI has been established in the first AMF controller 100a and transferred to the second AMF controller 100b, the second AMF controller 100b sends the S-NSSAI as pending S-NSSAI (S-NSSAI for which the NSSAA is pending) or a separate list of the S-NSSAI indicating the network slice re-authentication and re-authorization is pending which is different than network slice authentication and authorization to the UE 300. The UE 300 and the network maintains the PDU session related to the S-NSSAI.
3. The second AMF controller 100b sends the S-NSSAI as rejected S-NSSAI to the UE 300. The UE 300 and the network release the PDU session(s) related to the S-NSSAI.
4. The second AMF controller 100b sends the S-NSSAI as rejected S-NSSAI to the UE 300. The UE 300 and the network maintains the PDU session(s) related to the S-NSSAI.

In all the above cases the second AMF controller 100b will execute the network slice specific re authentication and re authorization for the S-NSSAI.

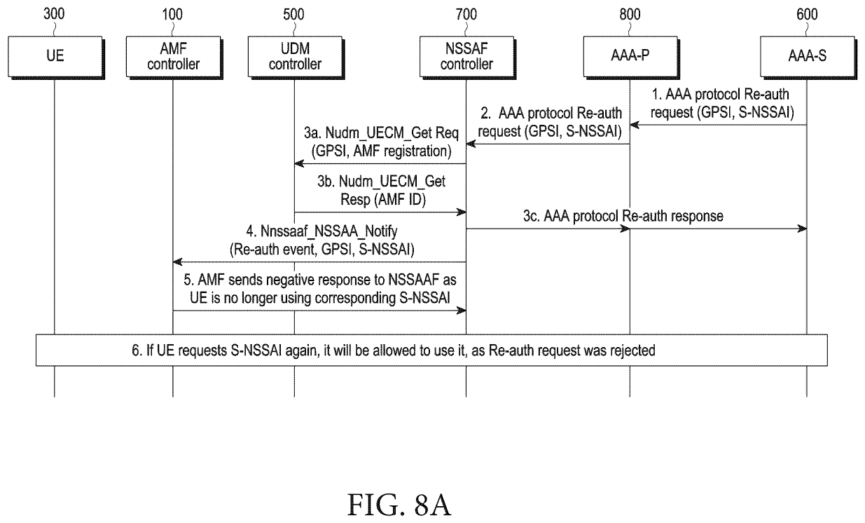

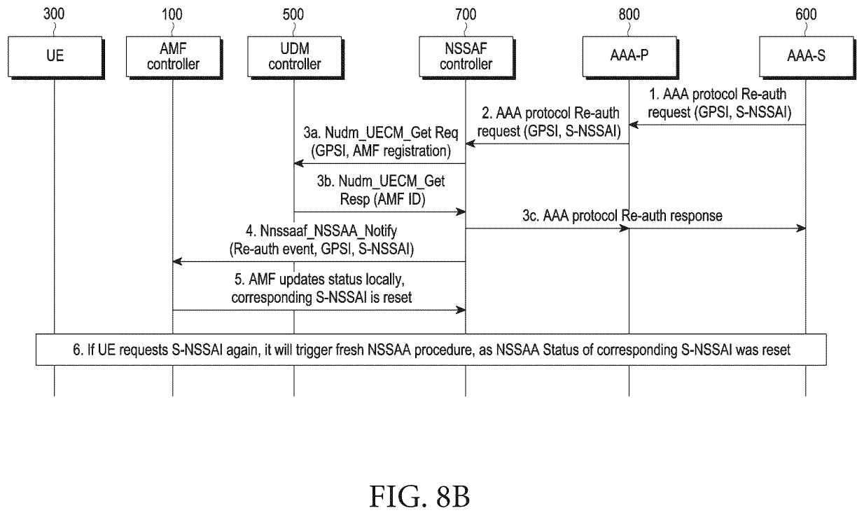

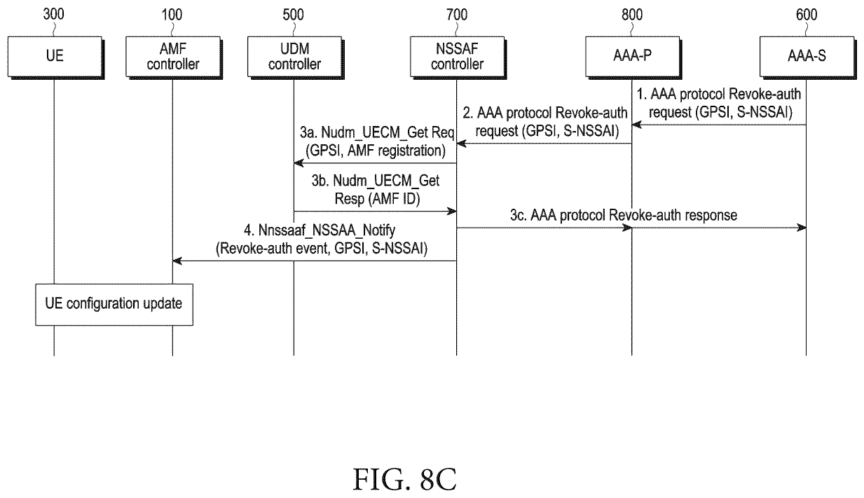

FIG. 8A is a signaling diagram illustrating the AAA server 600 triggered network slice-specific re-authentication and re-authorization procedure, according to embodiments of the present disclosure.

Referring to the FIG. 8A, consider that the AAA-S 600 initiates re-authentication or revocation and the UE 300 is not always registered in the 5GS or the S-NSSAI is not registered. To ensure that the NSSAA is executed in case the UE 300 later registers to the specific S-NSSAI, the AMF controller 100 updates the NSSAA status in the UE context. The NSSAA status is defined (TS 29.518 and TS 29.571) such that the NSSAA Status always includes the S-NSSAIs subject to NSSAA procedure and the status. Also, the status values defined are: “EAP_SUCCESS”, “EAP_FAILURE” or “PENDING”. However, there is no status equivalent when the subscription data is initially received by the AMF controller 100, i.e. before any NSSAA has been initiated. Whether the PENDING may be used in such case would be up to CT4 to define. Also, there needs to be a status value available for the initial case i.e. when the NSSAA is required next time the UE 300 tries to register the S-NSSAI.

Referring to the FIG. 8A, the step-by-step procedure for the AAA server 600 triggered network slice-specific re-authentication and re-authorization procedure includes.
1. The AAA-S 600 requests the re-authentication and re-authorization for the Network Slice specified by the S-NSSAI in the AAA protocol Re-Auth Request message, for the UE 300 identified by the GPSI in this message. This message is sent to a AAA-P 800, if the AAA-P 800 is used (e.g. the AAA-S 600 belongs to a third party), otherwise it is sent directly to the NSSAAF controller 700.
2. The AAA-P, if present, relays the request to the NSSAAF controller 700.
3a-3b. The NSSAAF controller 700 gets the AMF ID from the UDM 500 using Nudm_UECM_Get with the GPSI in the received AAA message.
3c. The NSSAAF controller 700 provides an acknowledgement to the AAA protocol Re-Auth Request message. If the AMF controller 100 is not registered in UDM the procedure is stopped here.
4. If the AMF controller 100 is registered in UDM, the NSSAAF notifies Re-auth event to the AMF to re-authenticate/re-authorize the S-NSSAI for the UE using Nnssaaf_NSSAA_Notify with the GPSI and S-NSSAI in the received AAA message. The callback URI of the notification for the AMF controller 100 is derived via NRF as specified in TS 29.501 [62].
5. The AMF controller 100 sends a negative response to the NSSAAF controller 700 as the UE 300 is no longer using corresponding S-NSSAI.
6. If the UE 300 requests S-NSSAI again, the UE 300 will be allowed to use the S-NSSAI, as Re-auth request was rejected.

FIG. 8B is a signaling diagram illustrating the AAA server 600 triggered network slice-specific re-authentication and re-authorization procedure, according to the embodiments as disclosed herein.

Referring to the FIG. 8B, an AMF logic is added to update the NSSAA status in case the AAA-S 600 invokes the re-authentication or the revocation procedure as to ensure a new NSSAA is executed in case the UE 300 tries to register the S-NSSAI again.
1. The AAA-S 600 requests the re-authentication and re-authorization for the Network Slice specified by the S-NSSAI in the AAA protocol Re-Auth Request message, for the UE 300 identified by the GPSI in this message. This message is sent to a AAA-P 800, if the AAA-P 800 is used (e.g. the AAA-S 600 belongs to a third party), otherwise it is sent directly to the NSSAAF controller 700.
2. The AAA-P, if present, relays the request to the NSSAAF controller 700.
3a-3b. NSSAAF controller 700 gets AMF ID from UDM using Nudm_UECM_Get with the GPSI in the received AAA message.
3c. The NSSAAF controller 700 provides an acknowledgement to the AAA protocol Re-Auth Request message. If the AMF controller 100 is not registered in UDM 500 the procedure is stopped here.
4. If the AMF controller 100 is registered in UDM 500, the NSSAAF controller 700 notifies Re-auth event to the AMF controller 100 to re-authenticate/re-authorize the S-NSSAI for the UE 300 using Nnssaaf_NSSAA_Notify with the GPSI and the S-NSSAI in the received AAA message. The callback URI of the notification for the AMF controller 100 is derived via NRF as specified in TS 29.501.
5. The AMF controller 100 updates the status locally and the corresponding S-NSSAI is reset on receiving the Nnssaaf_NSSAA_Notify.
6. If the UE 300 is registered with the S-NSSAI in the Mapping Of Allowed NSSAI, then the AMF controller 100 triggers the Network Slice-Specific Authentication and Authorization procedure defined in clause 4.2.9.1. If the S-NSSAI is included in the Allowed NSSAI for 3GPP access and non-3GPP access, the AMF controller 100 selects an access type to perform NSSAA based on network policies. If the S-NSSAI is only included in the Allowed NSSAI of non-3GPP access and the UE 300 is CM-IDLE in non-3GPP access, the AMF controller 100 marks the S-NSSAI as pending. In this case, when UE becomes CM-CONNECTED in non-3GPP access, the AMF controller 100 initiates NSSAA if needed.

If the UE 300 is registered but the S-NSSAI is not in the Mapping Of Allowed NSSAI, the AMF controller 100 removes any status of the corresponding S-NSSAI subject to Network Slice-Specific Authentication and Authorization in the UE context it may have kept, so that an NSSAA is executed next time the UE 300 requests to register with the S-NSSAI.

FIG. 8C is a signaling diagram illustrating the AAA Server 600 triggered network slice-specific revocation procedure, according to the embodiments as disclosed herein.

Referring to the FIG. 8C, the method for the AAA Server 600 triggered network slice-specific revocation procedure includes:
1. The AAA-S 600 requests the revocation of authorization for the Network Slice specified by the S-NSSAI in the AAA protocol Revoke Auth Request message, for the UE 300 identified by the GPSI in this message. This message is sent to AAA-P 800 if it is used.
2. The AAA-P 800, if present, relays the request to the NSSAAF controller 700.
3a-3b. The NSSAAF gets AMF ID from UDM using Nudm_UECM_Get with the GPSI in the received AAA message.
3c. The NSSAAF controller 700 provides an acknowledgement to the AAA protocol Re-Auth Request message. If the AMF controller 100 is not registered in UDM 500 the procedure is stopped here.
4. If the AMF controller 100 is registered in UDM 500, the NSSAAF controller 700 notifies Revoke Auth event to the AMF controller 100 to revoke the S-NSSAI authorization for the UE 300 using Nnssaaf_NSSAA_Notify with the GPSI and S-NSSAI in the received AAA message. The callback URI of the notification for the AMF controller 100 is derived via NRF as specified in TS 29.501.
5. If the UE 300 is registered with the S-NSSAI in the Mapping Of Allowed NSSAI, the AMF controller 100 updates the UE configuration to revoke the S-NSSAI from the current Allowed NSSAI, for any Access Type for which Network Slice Specific Authentication and Authorization had been successfully run on this S-NSSAI. The UE Configuration Update may include a request to Register if the AMF controller 100 needs to be re-allocated. The AMF controller 100 provides a new Allowed NSSAI to the UE 300 by removing the S-NSSAI for which authorization has been revoked. The AMF controller 100 provides new rejected NSSAIs to the UE 300 including the S-NSSAI for which authorization has been revoked. If no S-NSSAI is left in Allowed NSSAI for an access after the revocation, and a Default NSSAI exists that requires no Network Slice Specific Authentication or for which a Network Slice Specific Authentication did not previously fail over this access, then the AMF controller 100 may provide a new Allowed NSSAI to the UE 300 containing the Default NSSAI. If no S-NSSAI is left in Allowed NSSAI for an access after the revocation, and no Default NSSAI may be provided to the UE 300 in the Allowed NSSAI or a previous Network Slice Specific Authentication failed for the Default NSSAI over this access, then the AMF controller 100 shall execute the Network-initiated Deregistration procedure for the access as described in clause 4.2.2.3.3, and it shall include in the explicit De-Registration Request message the list of Rejected S-NSSAIs, each of them with the appropriate rejection cause value. If there are PDU session(s) established that are associated with the revoked S-NSSAI, the AMF controller 100 shall initiate the PDU Session Release procedure as specified in clause 4.3.4 to release the PDU sessions with the appropriate cause value.

If the UE 300 is registered but the S-NSSAI is not in the Mapping Of Allowed NSSAI, the AMF controller 100 removes any status it may have kept of the corresponding S-NSSAI subject to Network Slice-Specific Authentication and Authorization in the UE context

In one example, a solution may be the combination of any existing solutions defined above. The following definitions applies to the all the above embodiments.
5GLAN Group: A set of UEs using private communication for 5G LAN-type service.
5G Access Network: An access network comprising a NG-RAN and/or non-3GPP AN connecting to a 5G Core Network.
5G Core Network: The core network specified in the present document. It connects to a 5G Access Network.
5G LAN-Type Service: A service over the 5G system offering private communication using IP and/or non-IP type communications.
5G LAN-Virtual Network: A virtual network over the 5G system capable of supporting 5G LAN-type service.
5G System: 3GPP system consisting of 5G Access Network (AN), 5G Core Network and UE.
Allowed NSSAI: NSSAI provided by the Serving PLMN during e.g. a Registration procedure, indicating the S-NSSAIs values the UE could use in the Serving PLMN for the current Registration Area.
Configured NSSAI: NSSAI provisioned in the UE applicable to one or more PLMNs.
SNPN enabled UE: A UE configured to use stand-alone Non-Public Networks.
SNPN access mode: A UE operating in SNPN access mode only selects stand-alone Non-Public Networks over Uu.
Stand-alone Non-Public Network: A non-public network not relying on network functions provided by a PLMN
Subscribed S-NSSAI: S-NSSAI based on subscriber information, which a UE is subscribed to use in a PLMN
CAG only UE: a UE which is indicate by the network to access the 5GS by a CAG cell.
CAG Cell: The CAG cell shall broadcast information such that only UEs supporting CAG are accessing the cell.
Non-CAG cell: cell of a public PLMN. Normal cell where the UE may access public PLMN service.
Allowed CAG list: An Allowed CAG list of a UE is a list of CAG Identifiers the UE is allowed to access.

For the purposes of the present document, the abbreviations given in TR 21.905 [1] and the following apply. An abbreviation defined in the present document takes precedence over the definition of the same abbreviation, if any, in TR 21.905 [1].
5GC-5G Core Network
5GLAN-5G Local Area Network
5GS-5G System
5G-AN-5G-Access Network
5G-EIR-5G-Equipment Identity Register
5G-GUTI-5G Globally Unique Temporary Identifier
G-BRG-5G Broadband Residential Gateway
5G-CRG-5G Cable Residential Gateway
5G-RG-5G Residential Gateway
5G-S-TMSI-5G S-Temporary Mobile Subscription Identifier
5Q1-5G QOS Identifier
AF-Application Function
AMF-Access and Mobility Management Function
AS-Access Stratum
ATSSS-Access Traffic Steering, Switching, Splitting
ATSSS-LL-ATSSS Low-Layer
AUSF-Authentication Server Function
BSF-Binding Support Function
CAG-Closed Access Group
CAPIF-Common API Framework for 3GPP northbound APIs
CHF-Charging Function
CN PDB-Core Network Packet Delay Budget
CP-Control Plane
DL-Downlink
DN-Data Network
DNAI-DN Access Identifier
DNN-Data Network Name
DRX-Discontinuous Reception
DS-TT-Device-side TSN translator
ePDG-evolved Packet Data Gateway
EBI-EPS Bearer Identity
FAR-Forwarding Action Rule
FN-BRG-Fixed Network Broadband RG.
FN-CRG-Fixed Network Cable RG
FN-RG-Fixed Network RG.
FQDN-Fully Qualified Domain Name
GFBR-Guaranteed Flow Bit Rate
GMLC-Gateway Mobile Location Centre
GPSI-Generic Public Subscription Identifier
GUAMI-Globally Unique AMF Identifier
HR-Home Routed (roaming)
I-SMF-Intermediate SMF
LADN-Local Area Data Network
LBO-Local Break Out (roaming)
LMF-Location Management Function
LPP-LTE Positioning Protocol
LRF-Location Retrieval Function
MCX-Mission Critical Service
MDBV-Maximum Data Burst Volume
MFBR-Maximum Flow Bit Rate
MICO-Mobile Initiated Connection Only
MPS-Multimedia Priority Service
MPTCP-Multi-Path TCP Protocol.
N3IWF-Non-3GPP Inter Working Function
NAI-Network Access Identifier
NEF-Network Exposure Function
NF-Network Function
NGAP-Next Generation Application Protocol
NID-Network identifier
NPN-Non-Public Network
NR-New Radio
NRF-Network Repository Function
NSI-Network Specific Identifier
NSI ID-Network Slice Instance Identifier
NSSAI-Network Slice Selection Assistance Information
NSSF-Network Slice Selection Function
NSSP-Network Slice Selection Policy
NW-TT-Network-side TSN translator
NWDAF-Network Data Analytics Function
PCF-Policy Control Function
PDR-Packet Detection Rule
PDU-Protocol Data Unit
PEI-Permanent Equipment Identifier
PER-Packet Error Rate
PFD-Packet Flow Description
PPD-Paging Policy Differentiation
PPF-Paging Proceed Flag
PPI-Paging Policy Indicator
PSA-PDU Session Anchor
QFI-QOS Flow Identifier
QoE-Quality of Experience
RACS-Radio Capabilities Signaling optimization
(R)AN-(Radio) Access Network
RG-Residential Gateway
RQA-Reflective QoS Attribute
RQI-Reflective QoS Indication
RSN-Redundancy Sequence Number
SA NR-Standalone New Radio
SBA-Service Based Architecture
SBI-Service Based Interface
SCP-Service Communication Proxy
SD-Slice Differentiator
SEAF-Security Anchor Functionality
SEPP-Security Edge Protection Proxy
SMF-Session Management Function
SMSF-Short Message Service Function
SN-Sequence Number
SNPN-Stand-alone Non-Public Network
S-NSSAI-Single Network Slice Selection Assistance Information
NSSAA-Network Slice Specific Authentication and Authorization
SSC-Session and Service Continuity
SSCMSP-Session and Service Continuity Mode Selection Policy
SST-Slice/Service Type
SUCI-Subscription Concealed Identifier
SUPI-Subscription Permanent Identifier
TAC-IMEI Type Allocation Code
TNAN-Trusted Non-3GPP Access Network
TNAP-Trusted Non-3GPP Access Point
TNGF-Trusted Non-3GPP Gateway Function
TNL-Transport Network Layer
TNLA-Transport Network Layer Association
TSC-Time Sensitive Communication
TSN-Time Sensitive Networking
TSP-Traffic Steering Policy
UCMF-UE-radio Capability Management Function
UDM-Unified Data Management
UDR-Unified Data Repository
UDSF-Unstructured Data Storage Function
UL-Uplink
UL CL-Uplink Classifier
UPF-User Plane Function
URLLC-Ultra Reliable Low Latency Communication
URRP-AMF-UE Reachability Request Parameter for AMF
URSP-UE Route Selection Policy
VID-VLAN Identifier
VLAN-Virtual Local Area Network
W-5GAN-Wireline 5G Access Network
W-5GBAN-Wireline BBF Access Network
W-5GCAN-Wireline 5G Cable Access Network
W-AGF-Wireline Access Gateway Function

According to embodiments of the present disclosure, a method for managing network slice specific authentication and authorization (NSSAA) procedure in wireless communication network may be provided, and the method may comprise receiving, by a access and mobility management function (AMF) controller 100, a first Non-Access Stratum (NAS) message from a user equipment (UE) 300 with a request for at least one network slice selection assistance information (NSSAI) comprising at least one single network slice selection assistance information (S-NSSAI), wherein the at least one S-NSSAI is subject to NSSAA; performing, by the AMF controller 100, the NSSAA procedure for the at least one S-NSSAI with authentication authorization and accounting server (AAA-S) 600 in response to the first NAS message; initiating, by the AMF controller 100, a procedure for storing a status of the NSSAA procedure for the S-NSSAI at one node of a plurality of nodes; receiving, by the AMF controller 100, a second NAS message from the UE 300 with a request for the at least one NSSAI comprising the at least one S-NSSAI; fetching, by the AMF controller 100, the status of the NSSAA procedure for the at least one S-NSSAI from the at least one node; determining, by the AMF controller 100, whether the status of the NSSAA procedure for the at least one S-NSSAI is successful; and performing, by the AMF controller 100, one of: skip execution of the NSSAA for the at least one S-NSSAI, in response to determining that the status of the NSSAA procedure for the at least one S-NSSAI is successful, and reject the at least one S-NSSAI present in the requested NSSAI, in response to determining that the status of the NSSAA procedure for the at least one S-NSSAI is not successful.

According to embodiments of the present disclosure, the plurality of nodes may comprise a unified data management (UDM) controller 500, authentication server function (AUSF) controller 400, a authentication authorization and accounting proxy (AAA-P) 800, a policy and charging rules function (PCRF) controller 900 and the AAA-S 600.

According to embodiments of the present disclosure, the method may further comprise: receiving, by the node of the plurality of nodes, a re-authentication and re-authorization request message for the at least one NSSAI comprising the at least one S-NSSAI from the AAA-S 600 for the UE 300, wherein the UE 300 is identified by a generic public subscription identifier (GPSI) in the re-authentication and re-authorization request message; requesting, by the node, an AMF controller identity (ID) to which the UE 300 is registered from the UDM controller 500, wherein the node requests by sending the GPSI of the UE 300; receiving, by the node, a response from the UDM controller 500 indicating that the UE 300 is deregistered; sending, by the node, a message to the UDM controller 500 indicating that one of the re-authentication and re-authorization, and revocation is required for the at least one S-NSSAI; initiating, by the node, the procedure for storing at one of the plurality of nodes the indication that one of the re-authentication and re-authorization, and revocation is required for the at least one S-NSSAI; and sending, by the node, a message to the AAA-S 600 indicating that the UE 300 is de-registered.

According to embodiments of the present disclosure, the method may further comprise: receiving, by the AMF controller 100, the indication that one of the re-authentication and re-authorization, and revocation is required for the at least one S-NSSAI from the node of the plurality of nodes when the UE 300 is re-registered; determining, by the AMF controller 100, that one of the re-authentication and re-authorization, and revocation is required for the at least one S-NSSAI; and performing, by the AMF controller 100, one of: the NSSAA procedure for the at least one S-NSSAI, in response to determining that the re-authentication and the re-authorization is required, and reject the at least one S-NSSAI present in the requested NSSAI, in response to determining that the revocation of the S-NSSAI is required.

According to embodiments of the present disclosure, the procedure for storing the status of the NSSAA procedure may be initiated by sending a message to the node of the plurality of nodes, wherein the message comprises at least one of a subscription permanent identifier (SUPI) and a GPSI, the at least one S-NSSAI and the status of the NSSAA of the at least one S-NSSAI.

According to embodiments of the present disclosure, the method may further comprise: determining, by the AMF controller 100, that the S-NSSAI of a registered UE 300 is not available in a mapping of allowed NSSAI; and eliminating, by the AMF controller 100, the status of the NSSAA procedure for the at least one S-NSSAI in a UE context.

According to embodiments of the present disclosure, the method may further comprise: determining, by the AMF controller 100, that the S-NSSAI of a registered UE 300 is not available in a mapping of allowed NSSAI; storing, by the AMF controller 100, an indication in a UE context that the status of the NSSAA procedure for the at least one S-NSSAI in pending; receiving, by the AMF controller 100, a third NAS message from the UE 300 with a request to register with the at least one S-NSSAI for which the status of the NSSAA procedure is pending; and performing, by the AMF controller 100, the NSSAA procedure with AAA-S 600 in response to the third NAS message.

According to embodiments of the present disclosure, an access and mobility management function (AMF) controller 100 for managing network slice specific authentication and authorization (NSSAA) procedure in wireless communication network may be provided, and the AMF controller 100 may comprise: a communicator 120; a memory 140; a processor 160 coupled to the communicator 120 and the memory 140; a NSSAA controller 180 coupled to the communicator 120, the memory 140 and the processor 160, and configured to; receive a first NAS message from a UE 300 with a request for at least one NSSAI comprising at least one single network slice selection assistance information (S-NSSAI), wherein the at least one S-NSSAI is subject to NSSAA; perform the NSSAA procedure for the at least one S-NSSAI with a AAA-S 600 in response to the first NAS message; initiate a procedure for storing a status of the NSSAA procedure for the S-NSSAI at one node of a plurality of nodes; receive a second NAS message with a request for the at least one NSSAI comprising the at least one S-NSSAI from the UE 300; fetch the status of the NSSAA procedure for the at least one S-NSSAI from the at least one node; determine whether the status of the NSSAA procedure for the at least one S-NSSAI is successful; and perform one of: skip execution of the NSSAA for the at least one S-NSSAI, in response to determining that the status of the NSSAA procedure for the at least one S-NSSAI is successful, and reject the at least one S-NSSAI present in the requested NSSAI, in response to determining that the status of the NSSAA procedure for the at least one S-NSSAI is not successful.

According to embodiments of the present disclosure, the plurality of nodes may comprise a UDM controller 500, an AUSF controller 400, an AAA-P 800, a PCRF controller 900 and the AAA-S 600.

According to embodiments of the present disclosure, the NSSAA controller 180 may be further configured to: receive the indication that one of re-authentication and re-authorization, and revocation is required for the at least one S-NSSAI from the node of the plurality of nodes when the UE 300 is re-registered; determine that one of the re-authentication and re-authorization, and revocation is required for the at least one S-NSSAI; and perform one of: the NSSAA procedure for the at least one S-NSSAI, in response to determining that the re-authentication and the re-authorization is required, and reject the at least one S-NSSAI present in the requested NSSAI, in response to determining that the revocation of the S-NSSAI is required.

According to embodiments of the present disclosure, the procedure for storing the status of the NSSAA procedure may be initiated by sending a message to the node of the plurality of nodes, wherein the message comprises at least one of a subscription permanent identifier (SUPI) and a GPSI, the at least one S-NSSAI and the status of the NSSAA of the at least one S-NSSAI.

According to embodiments of the present disclosure, the NSSAA controller 180 may be further configured to: determine that the S-NSSAI of a registered UE 300 is not available in a mapping of allowed NSSAI; and eliminate the status of the NSSAA procedure for the at least one S-NSSAI in a UE context.

According to embodiments of the present disclosure, the NSSAA controller 180 may be further configured to: determine that the S-NSSAI of a registered UE 300 is not available in a mapping of allowed NSSAI; store an indication in a UE context that the status of the NSSAA procedure for the at least one S-NSSAI in pending; receive a third NAS message from the UE 300 with a request to register with the at least one S-NSSAI for which the status of the NSSAA procedure is pending; and perform the NSSAA procedure with AAA-S 600 in response to the third NAS message.

The foregoing description of the specific embodiments will so fully reveal the general nature of the embodiments herein that others may, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the scope of the embodiments as described herein.

What is claimed is:

1. A method performed by an access and mobility management function (AMF) in a wireless communication network, the method comprising:
receiving, from a network slice specific authentication and authorization function (NSSAAF), a notifying message to re-authenticate or re-authorize a single network slice selection assistance information (S-NSSAI);
identifying whether the S-NSSAI of a registered user equipment (UE) is in a mapping of allowed NSSAI; and
removing a status of the S-NSSAI associated with a network slice specific authentication and authorization (NSSAA) procedure in a UE context in case that the S-NSSAI of the registered UE is not in the mapping of the allowed NSSAI.

2. The method of claim 1, further comprising transmitting a response message, to the NSSAAF, indicating that the registered UE is no longer using the S-NSSAI.

3. The method of claim 1, further comprising updating a status of the NSSAA procedure and resetting the S-NSSAI.

4. The method of claim 1, further comprising triggering the NSSAA procedure in case that the S-NSSAI of the registered UE is in the mapping of the allowed NSSAI.

5. The method of claim 4, further comprising selecting an access type to perform the NSSAA based on a network policy in case that the S-NSSAI is in the allowed NSSAI for 3^{rd} generation partnership project (3GPP) access and non-3GPP access.

6. The method of claim 4, further comprising indicating the S-NSSAI as pending in case that the S-NSSAI is not in the allowed NSSAI for 3^{rd} generation partnership project (3GPP) access and the S-NSSAI is in the allowed NSSAI for non-3GPP access.

7. An access and mobility management function (AMF) in a wireless communication network, the AMF comprising:
a transceiver; and
a controller configured to:
receive, from a network slice specific authentication and authorization function (NSSAAF), via the transceiver, a notifying message to re-authenticate or re-authorize a single network slice selection assistance information (S-NSSAI),
identifying whether the S-NSSAI of a registered user equipment (UE) is in a mapping of allowed NSSAI, and
remove a status of the S-NSSAI associated with a network slice specific authentication and authorization (NSSAA) procedure in a UE context in case that the S-NSSAI of the registered UE is not in the mapping of the allowed NSSAI.

8. The AMF of claim 7, wherein the controller is further configured to transmit a response message to the NSSAAF indicating that the registered UE is no longer in using corresponding the S-NSSAI.

9. The AMF of claim 7, wherein the controller is further configured to update a status of the NSSAA procedure and resetting the S-NSSAI.

10. The AMF of claim 7, wherein the controller is further configured to trigger the NSSAA procedure in case that the S-NSSAI of the registered UE is in the mapping of the allowed NSSAI.

11. The AMF of claim 10, wherein the controller is further configured to selecting an access type to perform the NSSAA based on a network policy in case that the S-NSSAI is in the allowed NSSAI for 3^{rd} generation partnership project (3GPP) access and non-3GPP access.

12. The AMF of claim 10, wherein the controller is further configured to indicating the S-NSSAI as pending in case that the S-NSSAI is not in the allowed NSSAI for 3^{rd} generation partnership project (3GPP) access and the S-NSSAI is in the allowed NSSAI for non-3GPP access.
